(19) United States
(12) Patent Application Publication
(10) Pub. No.: US 2002/0184048 A1
(43) Pub. Date: Dec. 5, 2002

(54) Computer system and method for delivering documentation

(76) Inventors: Rudolf Gelhaus, Nuernberg (DE); Steffen Geschke, Nuernberg (DE); Erich Nees-Regnart, Fuerth (DE)

Correspondence Address: BAKER & BOTTS, 30 ROCKEFELLER PLAZA, NEW YORK, NY, 10112

(21) Appl. No.: 10/146,341

(22) Filed: May 15, 2002

(30) Foreign Application Priority Data
May 16, 2001 (DE) 10123796.0

(51) Int. Cl. G06F 17/60

(52) U.S. Cl. 705/1

(57) ABSTRACT

With a computer system and method for ordering documents, in particular technical documentation, the desired document (10) is initially selected via a document portal. Following selection of the document, a corresponding file is made available from a database (5) of a document management system (4) and—depending on the selected delivery mode—either a download operation to the customer or a transmission of the file to the print server of a printer (9) is performed. In the latter case, the data for generating the delivery note and/or invoice is likewise transmitted to the print server so that said server can print out both the desired document as well as the delivery note and/or the invoice. Payment can be processed via an external service provider (11) connected to the merchandise management system (8). Via said computer system it is possible to search for specific information in one or more documents. The identified locations are listed and can be viewed via the client computer. A printout, downloading or ordering of the information found is possible as described above.

### FIELD OF THE INVENTION

The invention relates to a method and a computer system for delivering a document, preferably technical documents.

### BACKGROUND OF THE INVENTION

A system for reproducing documents at a point-of-sale machine is disclosed in U.S. Pat. No. 4,528,643. The desired document is selected and the transmission of the respective data to the point-of-sale machine is initiated by entering a code number. The document is then printed out via the point-of-sale machine. Payment is made via a credit card number previously entered in the point-of-sale machine. This system has the disadvantage of a lack of flexibility and a lack of support for the user when selecting the desired document. Moreover, the user can call up the document only at the location of the machine and the document is delivered only at that location.

It is furthermore known from the prior art to provide documents on a website on the Internet for so-called downloading. This service may be provided either upon payment of a charge, or gratis. The so-called File Transfer Protocol (FTP) is usually used to transmit the respective file over the Internet, but other transmission protocols such as https, DAV, etc. are also possible.

It is also known from the prior art to order media, for example books, data media and other media, from an online shop. The desired book is first selected and the payment and delivery arrangements are input via a web portal. The book is then prepared for dispatch and is typically delivered by mail or by a courier service. The payment is usually processed by means of the ordering party's credit card number, but other modes of payment are also possible.

In the case of technical documents, the problem arises that it is necessary to archive the documents for a large number of devices and device types over a long period of time, which results in considerable costs. For example, it must be ensured that even a long time after delivery of a device or system, operating instructions, service and maintenance instructions, repair instructions and the like are available and can be ordered. This entails a considerable logistical effort, the costs of which are burdensome.

It is a problem from the point of view of the customer that, depending on the particular manufacturer and device, there are different points of contact to access technical documentation. For the customer there is no easy-to-use access facility to obtain technical documentation, and that also operates on a non-proprietary basis.

### SUMMARY OF THE INVENTION

The object of the present invention is to provide an improved computer system and method for creating a convenient access facility (searching and finding), and enabling the delivery or viewing of a document, in whole or in part, in particular technical documentation. Accordingly, the invention enables the provision of a quick and convenient, and at the same time cost-effective, access facility to documents. The invention furthermore enables the user to select different delivery modes and methods of payment.

The Internet or other networked computer systems provide the ideal platform for the present invention, since it supports the dissemination of information and further enables businesses to satisfy legal requirements for the archiving of documentation simply and inexpensively. More particularly, the present invention enables print documentation to be ordered by means of so-called printing on demand. The documentation can be delivered worldwide directly from one or more printing works, and due to automated processing, this can be processed with very short delivery times. While the service can be free of charge, in the case of a chargeable service, billing can be processed by an external service provider connected to a merchandise management system of the computer system according to the invention.

Furthermore, the present invention enables desired documents and information to be located quickly. A user is able to view, download or order only parts of a particular document, for example a partial printout of only the pages actually required. It is likewise also possible to combine various partial documents to form a new document, which is then delivered for downloading or as a printout. The download can be performed from a computer system or a document management system which preferably has a database. The documents can be stored in the document management system in their respective original format, as PDF files, or in another format suitable for display on a computer.

Access to documents that are available to only a specific group of people can be protected by means of a password and/or authentication of the user. On the other hand, the invention enables a plurality of manufacturers to provide their individual technical documentation on a common portal. This results both in cost savings, and creates for the customer a user-friendly and uncomplicated access facility to technical documentation which can be offered to the customer relatively inexpensively compared to conventional methods.

In addition, the customer is not forced to download the desired documentation and then print it out on a local printer. Instead, it can be printed on the printer of a printing works. This has the particular advantage for the customer that printing out on the printer of a printing works is considerably less expensive than on a local inkjet or laser printer.

A non-proprietary document portal according to the invention has the added advantage that the customer needs only a single point of contact to access various technical documents. The respective Uniform Resource Locator (URL) of the portal can be saved in the so-called “Favorites” or “Bookmarks” of the customer's Internet browser for quick access.

### BRIEF DESCRIPTION OF THE DRAWINGS

The present invention is described in greater detail below in conjunction with the drawings, in which:

FIG. 1 shows a schematic block diagram of an embodiment of the computer system according to the invention; and

FIG. 2 shows a flowchart of an embodiment of the method according to the invention.

### DETAILED DESCRIPTION OF THE INVENTION

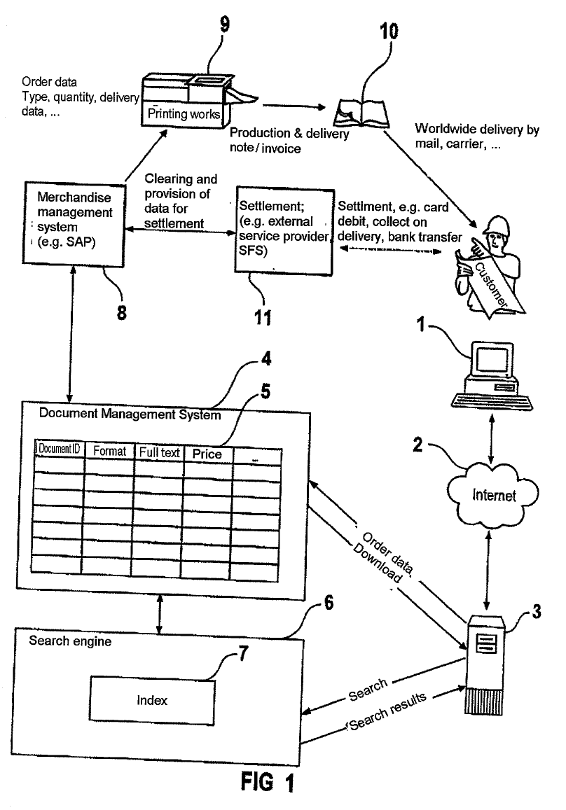

The computer system of FIG. 1 includes a client computer 1 of a customer. The client computer 1 has an interface for connection to the Internet 2. Via the Internet 2 the customer can make contact with a server computer 3 by means of the client computer 1. A website that provides a portal with a user interface is present on the server computer 3. The user interface has at least one input screen for selecting a desired document and for selecting the corresponding delivery mode. The customer can select as delivery modes, at least in the search for particular information and topics, the download of a corresponding file or a document or the ordering of a document (in whole or in part).

The server computer 3 is also connected to a document management system 4. The document management system 4 may likewise be implemented on the server computer 3 or on another server computer of the Internet 2. The document management system 4 includes a database 5. The database 5 has the following fields for each document for example: document identification number (ID); available document formats (data formats for downloading or printing formats, in particular loose-leaf pages, adhesive bound, stapled, bound, inter alia); availability of the document for full text searches; the price for the download and/or the printout, if appropriate depending on the format.

In the case where the computer system is used for technical documentation, the database 5 can include further data fields for each of the technical documents, such as the manufacturer of the device with which the technical document is associated, the device type, the device number, the manufacturing period, the device model and other details.

Furthermore, the server computer 3 can be connected to a search engine 6. As with the document management system 4, the search engine 6 can also be implemented on the server computer 3. It can likewise be implemented on another server computer of the Internet 2. The server computer of the search engine 6 need not necessarily be the same server computer of the document management system 4.

The search engine 6 has an index 7 which is automatically generated by the search engine 6 by searching through the documents available in the document management system 4. The document management system 4 is linked to a merchandise management system 8. The merchandise management system 8 can in turn be implemented on the server computer 3 or on another server computer of the Internet 2. Furthermore, the merchandise management system 8 can communicate with the document management system 4 also via a local area network, for example an intranet. The merchandise management system 8 can be a SAP system for example. A system from the Documentum company or the Hyperwave or Filenet programs can be used for example in the document management system 4.

The merchandise management system 8 and/or the document management system 4 are furthermore connected to a print server of a printer 9 of one or more printing works. The connection can likewise be established via the Internet 2 or via another data line. The printer 9 is a printing system which is designed for a high throughput and which therefore has low printing costs per page. The printer 9 prints a desired document 10 together with the associated delivery note and/or invoice. The document 10 is then delivered to the customer by mail, courier service or carrier.

Payment for the delivery of the document can be made for example by means of credit card, debit card, collect on delivery, bank transfer or other common modes of payment. The associated settlement can be handled by an external service provider 11 who communicates with the merchandise management system 8, for example via the Internet 2 or another data connection.

To access the desired documentation, the customer uses his client computer 1 to access the website on the server computer 3 with the document portal via the Internet 2. The customer then locates the desired document via the document portal. The document can be selected by means of a hierarchical index structure. For example, if the customer is searching for technical documentation for a product from the Siemens company, then he can first select Siemens in the top-level index, then the device type (for example mobile phone, household appliance, system controller, automotive electronics, etc.), in order then to select the actual device.

Alternatively, the customer can also use a search mask on the document portal to identify the desired document, or a single page/topic/information in a document, by means of search criteria and corresponding Boolean operators. After filling out the search fields, the corresponding search profile is transmitted to the search engine 6, which determines the relevant hits by means of its index 7. Said hits are transmitted back to the server computer 3 as search results and are offered to the customer for selection.

The selected document(s) can be collected in a virtual shopping cart. To finally order the documents selected, the customer must then enter his delivery data, the customer address and delivery address, as well as the data relating to the method of payment. Said data can be stored in a user profile on the server 3 or on the client computer 1 in a so-called cookie, so that the customer 1 at least in future does not need to enter all the data of the user profile for further orders.

The customer can furthermore select the delivery mode via the documentation portal, namely whether he wishes to download a corresponding file, the delivery of a printout, or to view the whole or part of the document. Said address, payment and delivery mode data is transmitted as order data to the document management system 4 and/or to the merchandise management system 8. If downloading is wished, a corresponding file is transmitted via the server 3 and the Internet 2 to the client computer 1. The customer I can then read the document on the screen of the client computer 1 and/or print it out on a local printer (not shown in FIG. 1).

If on the other hand the customer does not wish a download, but desires the delivery of the ordered document, then the corresponding data is sent from the document management system via the merchandise management system 8 to the print server of the printer 9. The data required for generating the delivery note and/or invoice is also transmitted to the print server of the printer 9, so that the printer 9 can print out the document 10, and the delivery note and/or the invoice together. If the printout of multiple identical documents 10 is wished, the relevant quantity specification is also transmitted to the printer 9.

Payment for the delivery of the document 10 is then made, for example, via the external service provider 11, who enters the corresponding payment data in the merchandise management system 8. This procedure can also be fully automated to a large degree.

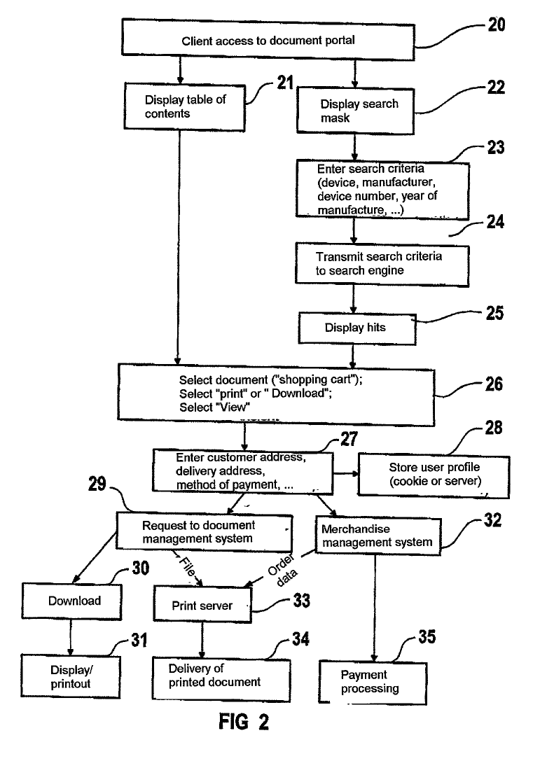

FIG. 2 shows a flowchart of an embodiment of the method according to the present invention. In step 20, the customer accesses the document portal via his client computer. In step 21, a table of contents with a hierarchical index is made available by the document portal for display on the client. In step 22 a search mask is displayed to the client via the document portal. In step 33 the user of the client computer can enter search criteria in the search mask. Said criteria may be, for example, the device type, the manufacturer, the device number, the year of manufacture, etc. Said search criteria can be combined using Boolean operators. The respective search profile is transmitted to a search engine of the document management system in step 24.

With the aid of its index, the search engine identifies one or more hits that match the search profile. Said hits are displayed on the client computer in step 25. In step 26 the desired document is selected either on the basis of the table of contents of step 21 or on the basis of the hits displayed in step 25.

In step 26 the selected document is placed in a shopping cart. The user's choice of delivery mode is likewise specified, i.e., as a download, or as a printed document. Steps 21 or 22 to 25 can then be repeated several times for selecting multiple documents.

To process the order, the user must then enter, in step 27, his customer address, the delivery address, the method of payment and/or further customer-specific data. Said data can be stored as a user profile in step 28. In this case the data can be stored on the client itself, for example as a so-called cookie, or on the server.

In step 29 a request for the selected document(s) is sent to the document management system. The document management system then executes a database query. Depending on the selected delivery mode, the respective file is then transmitted to the client as a download in step 30, which in step 31 can produce a printout on a local printer or display the found information/topics on the client computer. If on the other hand the delivery mode of printing works is selected, the respective file is transmitted to the print server.

The data entered in steps 26 and 27 is also transmitted to a merchandise management system in step 32. The order data required for the delivery note and/or the invoice is generated there and likewise transmitted to the print server.

In the print server in step 33 a corresponding print order for the printer of the printing works is generated, so that the latter generates in one operation a printout comprising the delivery note and/or invoice and the desired document itself. In step 34 the printed document together with the delivery note and the invoice is delivered to the customer, for example by mail or by courier service. Payment processing via the merchandise management system takes place in step 35.

1. A computer system comprising a website having a user interface for selecting a document and for selecting a delivery mode for the document; a document management system having a file to contain the document; means for transmitting at least a part of the selected document and selected delivery mode from the website to the document management system; and means for further transmitting the file depending on the selection of delivery mode.

2. The computer system according to claim 1, further comprising a merchandise management system and means for transmitting data relating to delivery and/or an invoice for delivery of a printed document to a print server, so that a printer of a printing works prints out the document together with the delivery mode and/or the invoice.

3. The computer system according to claim 2, wherein the payment for the delivery of the document is processed via the merchandise management system.

4. The computer system according to claim 1, wherein the document management system has a database which includes for each document, information including available format, full text search capability, price and/or other document-specific information depending on the delivery mode.

5. The computer system according to claim 4, wherein the document is a technical document and the database includes information about the technical device to which the document relates.

6. The computer system according to claim 1, wherein the document management system has a search engine.

7. The computer system according to claim 1, wherein transmitting the means is a computer network, including the Internet.

8. The computer system according to claim 1, further comprising means for user-friendly searching for specific information/topics in one and/or more documents, and means for displaying the information found.

9. A method for selecting and delivering a document using a computer system having a website and user interface, comprising selecting a document; selecting a delivery mode; transmitting the selected document and the selected delivery mode to a document management system; transmitting a file containing the selected document based on the selected delivery mode; and transmitting information contained in the documents for viewing on a client computer.

10. The method according to claim 9, wherein a printing works delivery mode is selected, data relating to delivery note and/or an invoice for the delivery of the printed document is transmitted from a merchandise management system to a print server so that a printer of the printing works can print out the document together with delivery instructions and/or the invoice.

11. The method according to claim 10, wherein the payment for the delivery of the document is processed via the merchandise management system.

12. The method according to claim 9, wherein a document management system is accessed to select the document.

13. The method according to claim 12, wherein a database of the document management system is accessed to select the document.

14. The method according to claim 12, wherein the document is selected based on specifications with respect to a technical device, its manufacturer, the model number, year of manufacture and/or further specifications.

15. The method according to claim 9, further comprising using a search engine in a document management system to select the document.
